(19) United States
(12) Patent Application Publication
(10) Pub. No.: US 2011/0203364 A1
(43) Pub. Date: Aug. 25, 2011

(54) Method and Apparatus for Determining Resource Consumption

(75) Inventors: Thorsten Staake, Gelnhausen (DE); Thomas Stiefmeier, Reichelsheim (DE)

(73) Assignee: Amphiro AG, Zurich (CH)

(21) Appl. No.: 13/030,211

(22) Filed: Feb. 18, 2011

Related U.S. Application Data
(63) Continuation-in-part of application No. PCT/EP2009/060887, filed on Aug. 24, 2009.

(30) Foreign Application Priority Data
Aug. 23, 2008 (DE) 10 2008 039 272.3

(51) Int. Cl. G01F 1/075; F16K 21/00; G01F 15/00

(52) U.S. Cl. 73/198; 137/801; 73/861.77

(57) ABSTRACT

A method for determining the resource consumption in the usage of a fluid, in particular water, withdrawn from a withdrawal site, determines the amount of fluid withdrawn from the withdrawal site during a withdrawal unit. The fluid quantity is based either on the fluid quantity of an individual withdrawal process or the fluid quantity of an overall withdrawal process combining several individual withdrawal processes. The overall withdrawal process is taken into account when the individual withdrawal processes take place in a time interval that is smaller than a predetermined time window.

### RELATED APPLICATIONS

This application is a continuation-in-part of International application No. PCT/EP2009/060887 filed Aug. 24, 2009. Priority is claimed on German application no. 10 2008 039 272.3 filed Aug. 23, 2008.

### FIELD OF THE INVENTION

The present invention relates to a method and a device for determining a consumption of resources.

### BACKGROUND OF THE INVENTION

The provision of cold and hot water requires a considerable use of natural resources on the part of both the supply companies and the consumers. The operation of water processing plants, pumping stations and sewage treatment plants and the provision of hot water are especially energy-intensive. Due to water's high specific heat storage capacity of 4.183 J Kg⁻¹ K⁻¹, large amounts of energy are consumed even for many everyday activities; thus a four-minute hot shower requires 1.5 kWh of heat energy to be supplied, which is usually provided by fossil fuels or electrical energy. In European countries and in North America, the use of water represents a considerable part of primary energy consumption, which entails greenhouse gas emissions and expenses according to today's state of the art.

Despite the growing environmental consciousness, many consumers are insufficiently aware of the connections between water consumption and energy consumption. Water is indeed considered a precious resource by the overwhelming part of the population, but water consumption is only rarely connected to the emission of greenhouse gases and the use of nonrenewable resources, and is thus not included in efforts for climate protection. In addition, consumers lack the possibility of assessing individual withdrawal processes with respect to resource consumption. Monthly or even yearly accounting cycles for utility costs offer only slight information about the resource intensity of individual activities; installed water, power, gas, heat and electricity meters likewise allow only insufficient inferences for individual uses. Another disadvantage of the known systems results from the lack of an automatic recognition of related withdrawal processes and the lack of a combination of individual related measurement values with respect to characteristic parameters that characterize finished activities. In addition, the resource consumptions produced by hot water withdrawal are detected at multiple measurement points such as the water meter and the gas meter, and would have to be read separately by the consumer, assessed and combined. Combination into easily interpreted characteristic parameters is not possible for most consumers and is too elaborate, especially for short withdrawal processes, such as washing hands. Furthermore, existing systems do not detect the energy expense that must be borne outside the consumer's area of responsibility, such as those for pumping stations. Consequently, behavior is not directly assessed in most cases, and existing systems lead to only marginal changes of behavior.

In addition to their limited functionality, most systems require an external power supply or a battery and are not suitable for installation directly at the point of withdrawal due to their dimensions, particularly if the consumer has high standards with respect to the aesthetics of the installation. An external power supply makes installation in a damp area particularly difficult, while an internal battery is not desirable for environmental aspects.

Documents EP 1308701A2; U.S. Pat. No. 3,342,070; EP 0288448A1; EP 0950877A2; U.S. Pat. No. 5,721,383; U.S. Pat. No. 4,885,943; WO 2008018836 and EP 0990877A2 describe equipment for detecting flow quantities. EP 1858144A2 describes an architecture with improved protection against failure of the power supply. U.S. Pat. No. 6,612,188 shows the utilization of the Wiegand effect as a magnetic sensor in a device for determining a flow quantity. The Wiegand effect requires usage of expensive material and is therefore disadvantageous. EP 1884292A1 describes a measurement device that detects and controls the water consumption at a garden sprinkler or a water faucet.

A device for determining the quantity of heat transported in a medium is described in DE 102004054118. For this purpose, the device detects the flow quantity of the medium as well as the temperature upstream and downstream of the heat transfer. Measuring the temperature at two points is characteristic for heat quantity measurement devices of this type, which complicates the construction. WO 2007/053091 A1 specifies a device for separate detection of the amount of energy required for service water and for water in radiators. Document GB 2434207 A is concerned with a water and energy costs monitor.

In an application of related devices as consumption information systems at the point of water withdrawal, there are disadvantages among existing devices, particularly due to a lack of mechanisms for recognizing associated withdrawal processes; due to an insufficient possibility for associating consumption information with individual withdrawal processes; due to an inadequate aggregation of measured values into a characteristic parameter characterizing the withdrawal process; due to a lack of information on the greenhouse gas emissions produced by the withdrawal; due to a high installation-related expense for determining the water temperature upstream of the water processing to determine the amount of expended thermal energy; due to the spatial separation between display and point of user interaction or the controller of the water withdrawal; due to the lack of application-related and situation-related information to assess behavior; as well as due to the use of expensive devices for energy supply.

### SUMMARY OF THE INVENTION

One object of the invention is to solve the problem of acquiring resource consumption including water consumption, energy consumption for preparing hot water, expenses for pumping etc. for withdrawal processes of hot or cold water, of allocating this consumption to individual withdrawal processes, determining the resulting characteristic parameters with respect to costs and environmental influences such as water volumes, energy amounts, greenhouse gas emissions etc., and visualizing them at the point of withdrawal or the point of control of such a withdrawal process and supporting the assessment of the user's own behavior, as well as creating incentives for an environmentally protective and cost-saving behavior.

Another object of the invention is to solve the problem of developing a device that requires no external power supply or external sensors in order to reduce the expense for installation, as well as being easily integrated with respect to overall size and shape, including aesthetic aspects, into existing installations such as those in the kitchen at the sink faucet, and in the bathroom at the washbasin, bathtub or shower faucet.

Another object of the invention is to provide a method and a device in order to detect resource consumption inexpensively.

The arrangement described below simplifies the measurement, determination and display of information on the use of hot and cold water that supports or motivates the consumer to reduce the resource consumption caused by water usage, as well as the associated emission of greenhouse gases. This information comprises, alone or in combination, data on costs incurred, consumed water volumes, required energy amounts, greenhouse gases produced, as well as information for comparison with similar user groups and the presentation of trends with respect to consumption behavior. Information is acquired and displayed both continuously during the water withdrawal and in aggregated form for related withdrawal processes. The display takes place in the direct spatial vicinity of the device controlling the withdrawal, i.e. the water faucet in the kitchen, the bath or garden, the shower head or the shower hose, the mixing tap, etc.

For this purpose, the device measures the flow quantity and the temperature of the fluid. A turbine wheel that is manufactured from magnetized material or mechanically connected to one or more permanent magnets is used to determine the flow quantity. In case of a withdrawal of water, the turbine wheel is set into rotational movement and generates an alternating magnetic field in one or more coils. The characteristic curve of the resulting voltage serves as an indicator of the rotational frequency and, after conversion, the flow quantity. The induced voltage can additionally be used as an energy source for the device, which makes it possible to dispense with a battery or large storage capacitors. The quantity of heat expended for heating the water is determined on the basis of an individual temperature sensor and a microcontroller, both housed in the device, and a method described below for estimating the water temperature prior to heating. The costs and environment-relevant parameters ascribable to the withdrawal are calculated by an evaluation of the expended amount of energy, taking into account, if necessary, the type of energy conversion such as using electrical energy versus direct usage of fossil fuels versus solar collectors, as well as an assessment of the withdrawn amount of water, also taking into account for the calculation of the greenhouse gas emissions the emissions that arise in the provision of cold water or the disposal of wastewater, for utility companies for instance. The factors necessary for this are stored in the microcontroller's memory.

The grouping of individual water withdrawals into related withdrawal processes is done with the aid of a microcontroller by evaluating the duration of individual water withdrawals and the time intervals between two or more than two withdrawals. When a turbine wheel is used for power generation, there is sometimes not enough energy available between two withdrawal processes to operate a low-cost timer. In this case, the measured temperature change from just before the switch-off until the next switch-on can serve as the time basis; alternatively, the voltage difference at a capacitor can be used for evaluation. The above-specified consumption information can be displayed in aggregated form for related withdrawal processes and therefore requires no calculation by the user. As an example, the brief opening of the water faucet to moisten a toothbrush and the reopening for rinsing the mouth and cleaning the toothbrush would be combined into one withdrawal process, but washing hands half an hour later would be a new measurement, with a reset water meter for example.

Frequently, not all acquired consumption information is of interest, or only a selection could be displayed for technical reasons. In this case, the information of interest of the user can frequently be derived from the course over time of the flow quantity and the temperature. The device recognizes characteristic curves of measurement parameters, ascribes them to the most probable context, such as hand-washing, showering, watering the garden, metering water, etc., and selects the display mode defined for this context. Thus for instance, a slow reduction of the fluid flow after an abrupt opening of a valve, “switch-on process,” can be inferred as a metered process in which the volume of the fluid withdrawn since the abrupt switch-on event is very probably of primary interest, for which reason information on this withdrawn water amount is preferably displayed.

If needed, the device can be further equipped with a communication interface and a nonvolatile data memory.

In one embodiment, the information comprises data on the quantity of energy expended in the preparation of cold water, in particular with respect to the quantity of energy for pumping, cleaning, distribution or processing, or a combination thereof.

In one embodiment, the information comprises data on the total quantity of energy expended in providing the withdrawn water.

In one embodiment, the information comprises data on the resulting greenhouse gas emissions.

In one embodiment, the display alternates between the information described above or below, or a selection thereof.

In one embodiment, individual information items listed above or below are selected automatically based on the flow quantity, the change over time of the flow quantity or the water temperature.

In one embodiment, trends in user behavior are recognized and displayed.

In one embodiment, no external electrical energy source or internal battery is needed for operation.

In one embodiment of a method for determining a signal indicating the resource consumption, a fluid quantity is determined for a fluid that is withdrawn at a withdrawal site during a withdrawal unit. The signal indicating the resource consumption is determined as a function of the amount of fluid determined during the withdrawal unit.

In one embodiment, a temperature of the withdrawn fluid is determined as the actual temperature. The signal indicating the resource consumption can be determined as a function of the amount of fluid determined during the withdrawal unit and additionally as a function of the actual temperature determined during the withdrawal unit.

The fluid can comprise water.

Alternatively, the resource consumption value can be determined from the difference between the actual temperature and a base temperature.

The actual temperature value can be determined per time unit. The signal indicating the resource consumption can be determined as a function of the amount of fluid determined during the withdrawal unit and the actual temperature per time unit determined during the withdrawal unit.

A withdrawal unit can be an individual withdrawal process.

Alternatively, a withdrawal unit can be an individual withdrawal process or, if the individual withdrawal processes take place in a time interval that is smaller than a predetermined time window, an overall withdrawal process that is composed of several individual withdrawal processes. The amount of fluid can be the amount of fluid of the individual withdrawal process or the amount of fluid of the overall withdrawal process.

In one embodiment, an arrangement for determining the resource consumption comprises a generator for generating an output voltage by means of the fluid, in particular water, flowing through the arrangement during a withdrawal unit, and an electronics component. The electronics component can be designed to determine an amount of fluid of the fluid flowing through the arrangement during the withdrawal unit from the output voltage of the generator, and to provide a signal indicating the resource consumption as a function of the output voltage of the generator.

In one embodiment, the electronics component is designed to base the withdrawal unit on an overall withdrawal process composed of several individual withdrawal processes if the individual withdrawal processes take place during a time interval that is smaller than a predetermined time window.

The time window can be a time t with t≦t₂, where a time duration t₂ is determined from the group comprising the average duration of tooth brushing, the average duration of hair washing and the average duration of lathering up.

A time t with 1 sec≦t≦5 min can be defined as the time window.

In one embodiment, the fluid flowing through the arrangement during a withdrawal unit is subsequently withdrawn at the withdrawal site. The withdrawal site is downstream of the arrangement.

In one embodiment, the arrangement comprises a temperature sensor for emitting a temperature signal that depends on a temperature of the fluid. The electronics component is designed to provide a signal indicating the resource consumption as a function of the temperature signal and the output voltage of the generator.

In one embodiment, the electronics component is designed to provide the signal indicating the resource consumption also as a function of a base temperature. A measured lowest temperature during a number M of previous individual withdrawal processes, or a base value is defined as the base temperature.

In one embodiment, for water as the fluid, a mean temperature that water has at delivery to a supply network is determined as the base value.

The electronics component can comprise a microcontroller. The microcontroller can be designed to combine individual withdrawal processes into an overall withdrawal process by means of an evaluation of a duration of individual withdrawal processes and the time intervals between two or more individual withdrawal processes.

In one embodiment, the generator is designed to generate the output voltage of the generator in such a manner that the output voltage of the generator can operate the electronics component.

In a refinement, the generator comprises a turbine wheel that is designed to be set into rotational motion by the fluid flowing through the arrangement.

The turbine wheel can be produced from magnetized material. Alternatively, the turbine wheel can be connected to at least one magnet. The at least one magnet can be situated in the fluid.

The arrangement can further comprise an interior housing. The generator can comprise at least one coil. The at least one coil can be mounted on a side of the interior housing facing away from the fluid in such a manner that an alternating magnetic field flows through the at least one coil during the rotational movement. The turbine wheel can be arranged together with the at least one magnet in the interior of the interior housing and fluid can flow around it.

In one embodiment, the arrangement comprises a housing. The housing can have a thread or a coupler that is designed for connection to a water faucet, a shower head, a shower hose, a mixing tap, a water line, or a garden hose.

In one embodiment, the arrangement can comprise a display module. The display module is used to display the signal indicating the resource consumption.

In one embodiment, the diodes for lighting the display can transmit data gathered by the device to an external device with the aid of data modulation methods.

In a refinement, the arrangement comprises a rectifier module for generating a supply voltage from the output voltage of the generator. The at least one coil can be connected to the rectifier module.

A water withdrawal device, in particular a faucet, a shower head, a shower hose, a mixing tap, a garden hose or a water line, can comprise an arrangement for determining the resource consumption.

In one embodiment, the arrangement for determining the resource consumption is constructed as a device.

### BRIEF DESCRIPTION OF THE DRAWINGS

The invention will be described below for several exemplary embodiments with reference to the figures; individual modules or functional units are described, wherein a shift of components or functions into other modules is implicitly included in the description. Areas and structures with identical function or effect bear identical reference numbers. Therein:

FIG. 1 shows an example of a schematic structure of a device or a described method, with integrated display,

FIG. 2 shows another example schematic structure of the device or the described method, with a separate display,

FIG. 3 shows an example of a rotor functioning as a sensor and generator of the described device or the described method,

FIG. 4 shows a block diagram of an example of the device or the method described in FIG. 1 with an integrated display,

FIG. 5 shows a block diagram of an example of the device or the method described in FIG. 2 with a separate display,

FIG. 6 shows an example of a possible circuit diagram of the rectifier module, with the optional optical communication configuration of the device or method described in FIG. 1,

FIG. 7 shows an example of a possible circuit diagram of the electronics for the rectifier module and the optical transmission of the measured information to a separate device,

FIG. 8 shows several exemplary water withdrawals and their grouping into combined withdrawal processes,

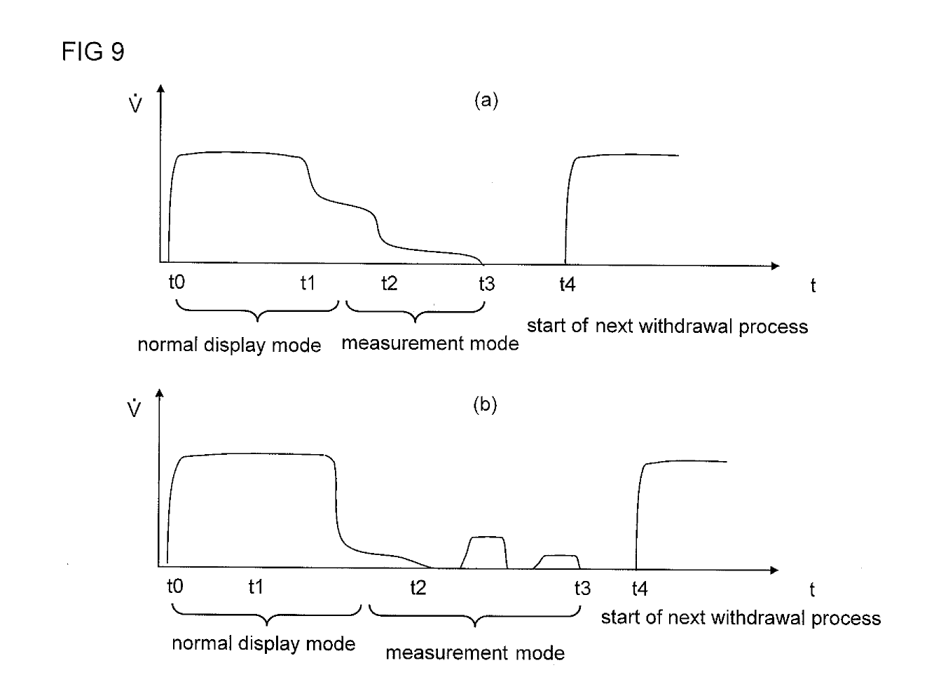

FIG. 9 shows exemplary measurement processes, their grouping into combined removal processes and the resulting display mode, and

FIGS. 10 to 12 show exemplary embodiments of water withdrawal devices, such as a hose, a shower head and a mixing tap.

### DETAILED DESCRIPTION OF THE DRAWINGS

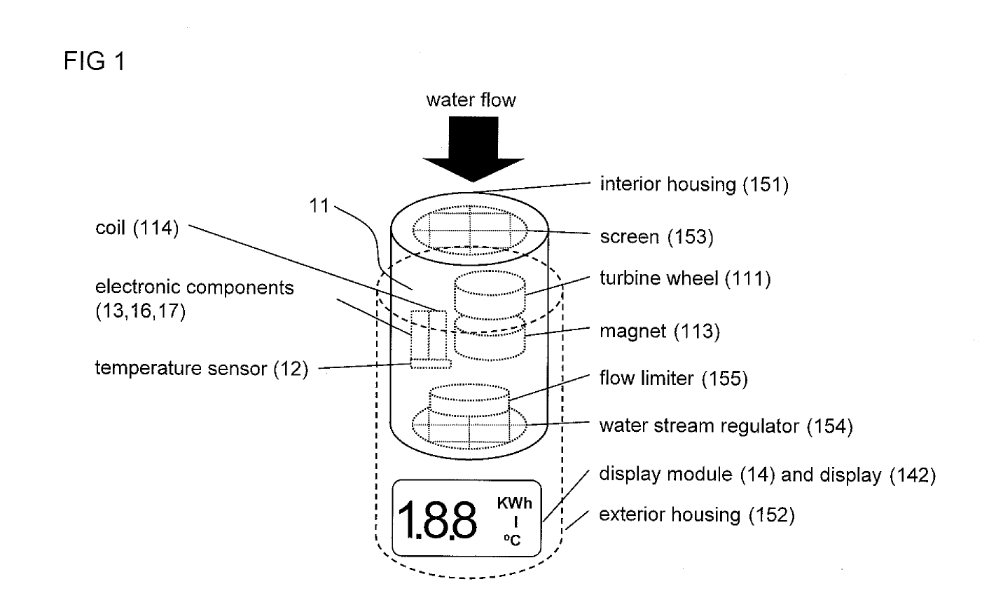

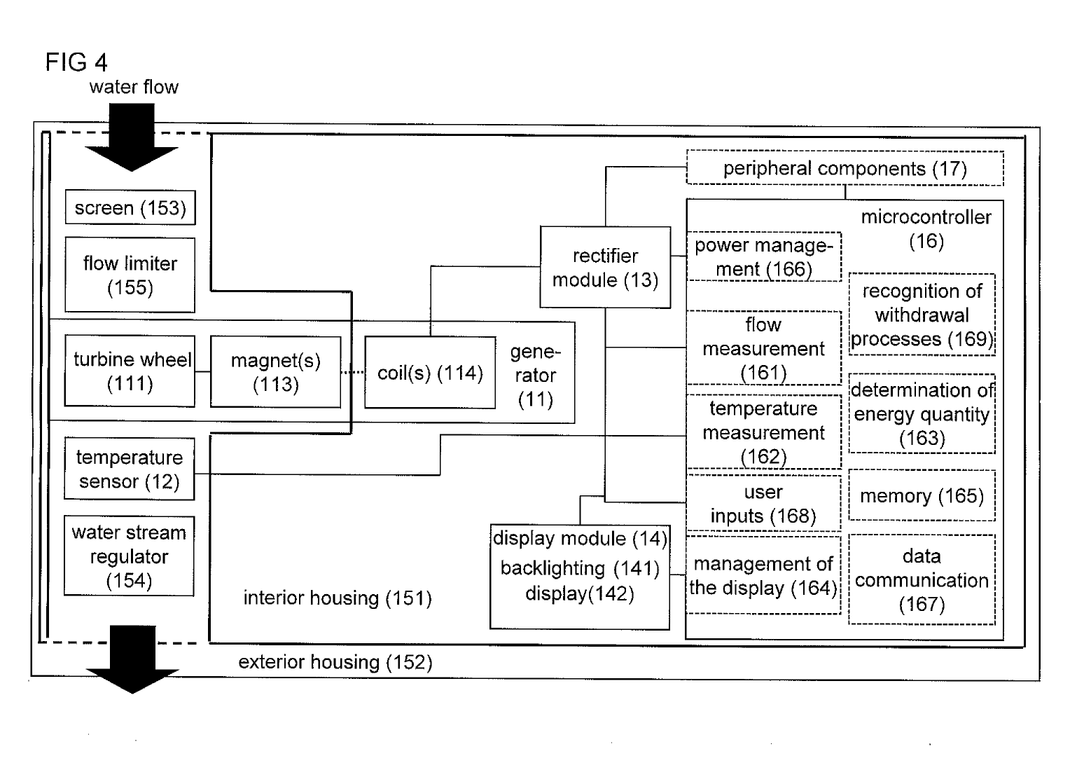

As sketched in FIGS. 1-5, the device or the method can be described by means of the cooperation of a generator 11, whose output voltage is used both as an indicator of the flow quantity and for supplying a voltage to the electronics components; a temperature sensor 12, a rectifier module 13 with smoothing capacitors and elements for protection from overvoltage, a microcontroller 16; an internal or external display module 14; and an interior and exterior housing 151 and 152 with, in addition to other components, a screen 153, an optional water stream regulator 154, as well as an optional flow limiter 155.

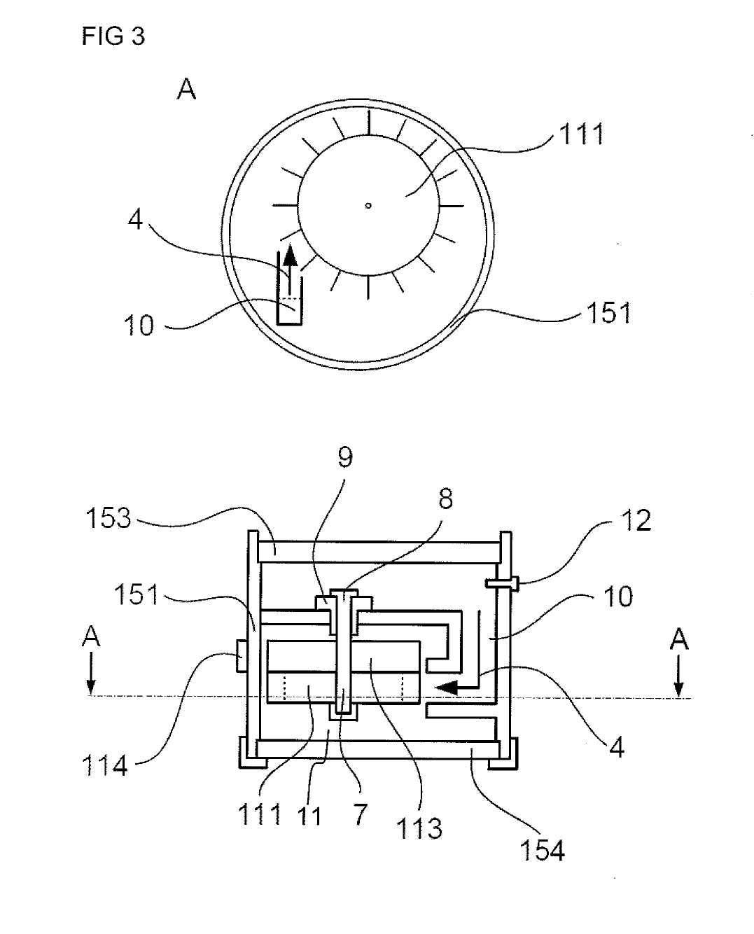

The generator 11 has a rotor/turbine wheel 111 that is set into a rotational motion by the water flowing through the device; in a preferred configuration, the water is deflected via one or more channels 10 in such a manner that it flows tangentially onto the turbine wheel 111, see FIG. 3 in particular; alternatively, a turbine wheel 111 can be used onto which water flows parallel to the axis. The turbine wheel 111 comprises a shaft 7, 8. The turbine wheel 111 is seated with low friction, preferably with the aid of a slide bearing 9. In a preferred configuration, the rotor is either itself magnetized diametrically or sectorally, or is mechanically connected to corresponding permanent magnets 113. One or more coils 114 are mounted on the outer side of the interior housing 151, so that an alternating magnetic field flows through them in case of a rotational motion of the rotor. In a design in which the rotor has n pole pairs or is connected to a magnet 113 that has n pole pairs, 2n coils 114 are preferably mounted such that the induced voltages of the individual coils 114 can be added up to a 2n-fold voltage in a series connection. The generator 11 is designed such that, even for low flow amounts, a voltage that is high enough to operate the electronics components is generated.

The temperature sensor 12, preferably an analog PTC or NTC or an integrated circuit with analog or digital output, is mounted in such a manner that the temperature of the medium can be determined without delay to the extent possible.

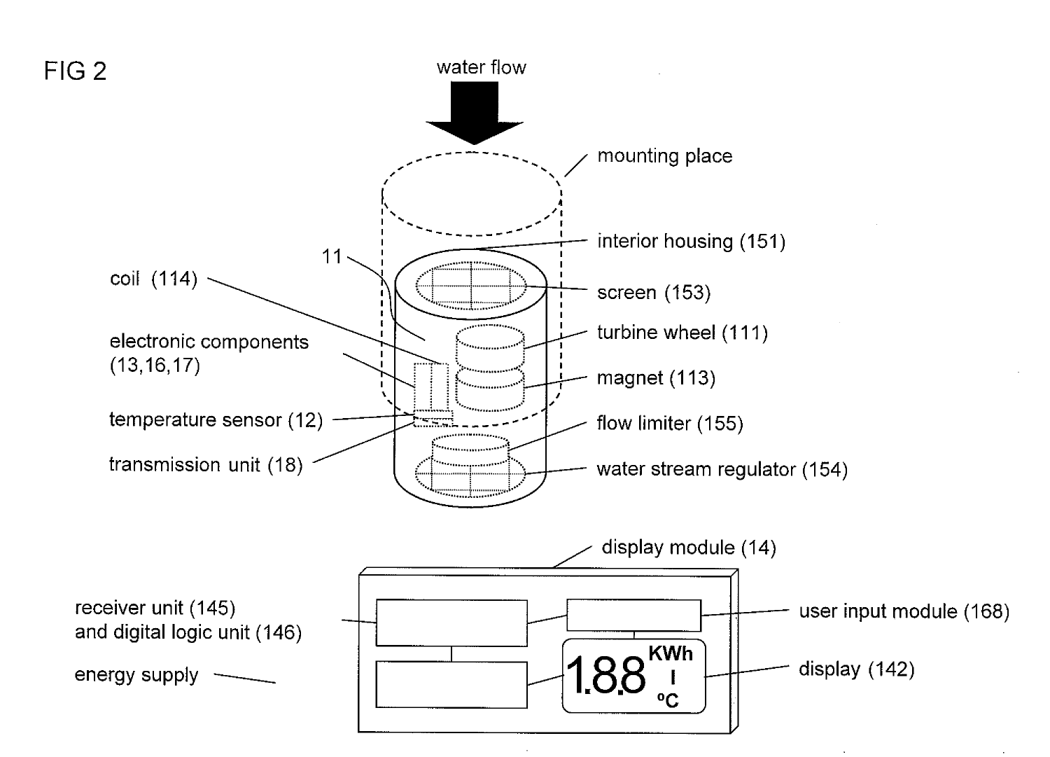

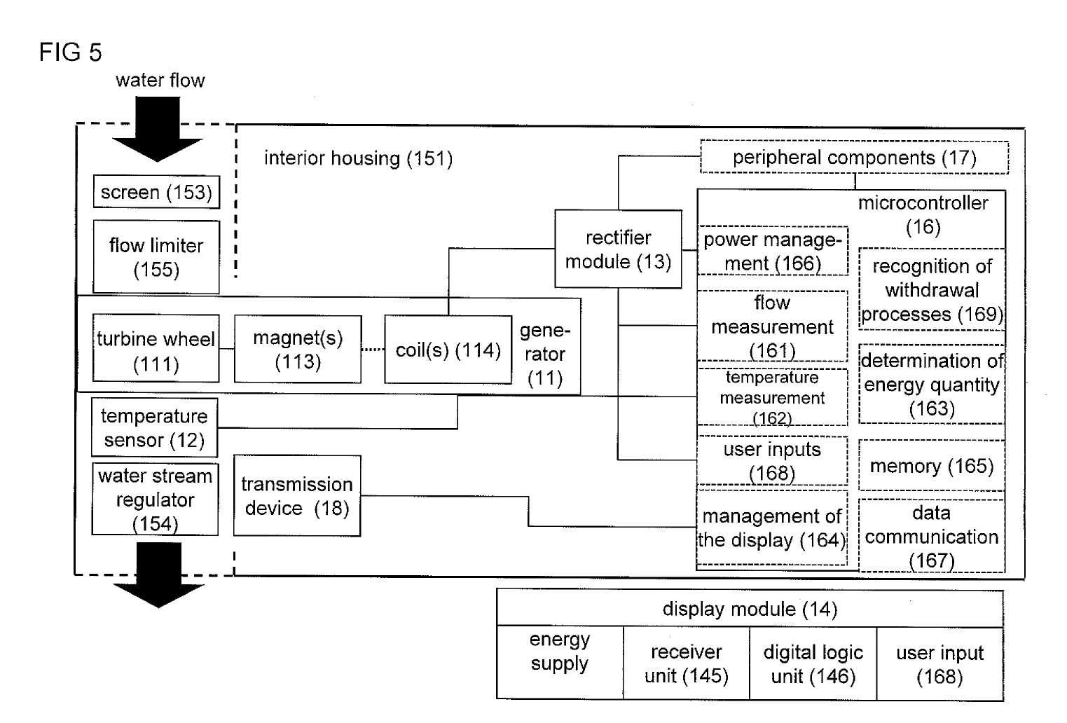

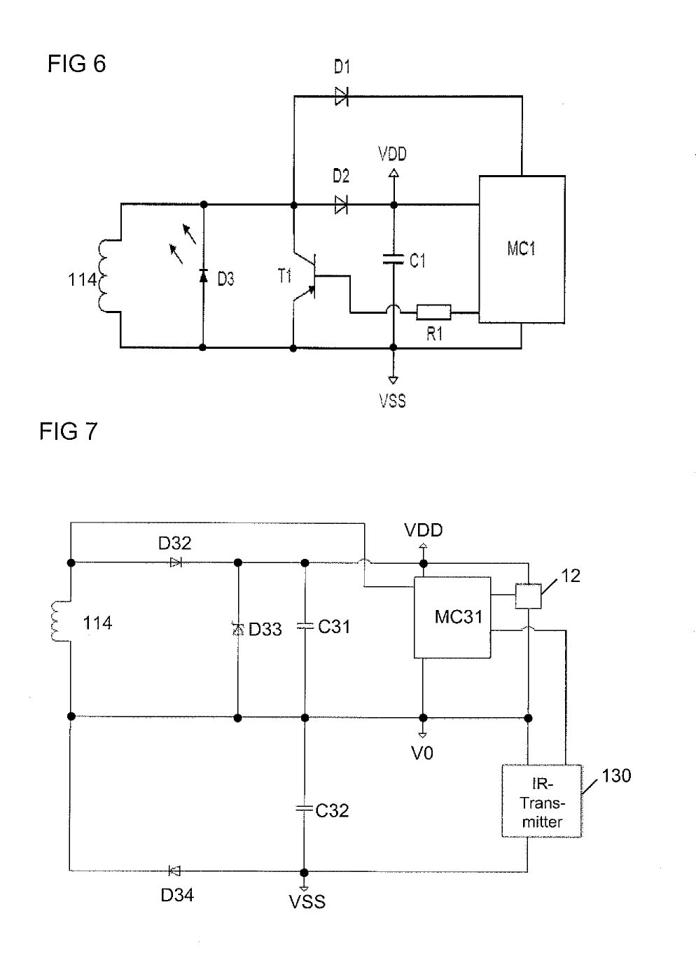

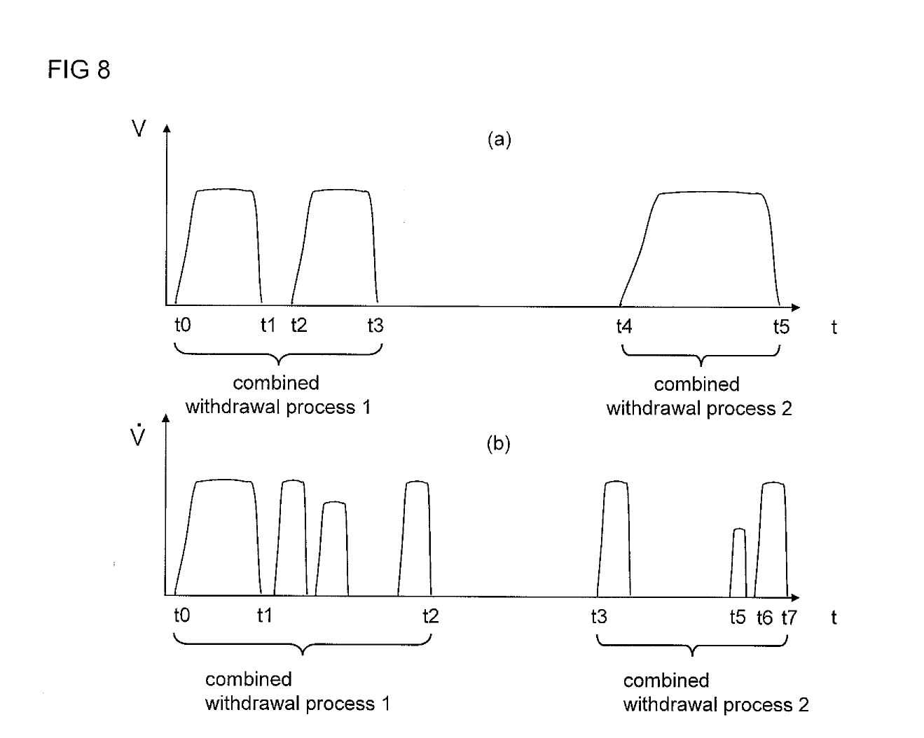

The rectifier module 13 shown in FIG. 6 has one or more diodes with low-voltage loss D2, D32, D34, preferably Schottky diodes, and one or more smoothing capacitors C1, C31, C32. Also see FIG. 6. As already mentioned, the generator 11 is designed in such a manner that the generated voltage is higher than the highest minimum supply voltage of the electronic components, even for low flow quantities. For high flow quantities, this results in a supply voltage VDD that can damage the electronic components. For protection from overvoltage, diodes with an on-state voltage greater than the minimum supply voltage and less than the maximum desired supply voltage are inserted upstream of the rectifier diodes D2, D32, D34; in a preferred configuration, the diodes are light-emitting diodes D3, abbreviated LEDs, with which the later-described display 14 is illuminated or with the aid of which the water stream 141 is illuminated. Alternatively, Zener diodes D33 can be used. For the above-described usage of light illuminating diodes D3 upstream of the rectifier diodes D2, the internal resistance of the generator 11 replaces an additional current limiter. In addition to the supply voltage VDD, the rectifier module 13 provides a signal from which the rotational frequency of the generator 11 can be derived. If an external display module 14 is used, see FIGS. 2 and 5 in particular, rectification is done according to FIG. 7, wherein one half-wave of the generator 11 is used to supply a transmission device or transmission module 18, and the other half-wave is used for supplying, in particular, the digital logic unit MC31 or 16, 17. The advantage of this is a higher efficiency as well as the possibility of supplying the logic unit and the transmission unit 18 with different voltage levels. The rectifier module 13 in accordance with FIG. 7 comprises an IR transmitter 130. The digital logic unit MC31 is implemented as a microcontroller MC31.

The rectifier module 13 in accordance with FIG. 6 comprises an additional diode D1. The rectifier 13 has a digital logic unit MC1. The digital logic unit MC1 is implemented as a microcontroller. A transistor T1 is driven by the digital logic unit MC1 via a resistor R1.

A numeric, alphanumeric or dot matrix liquid crystal or light emitting diode display is used as the internal or external display module 14. Lighting or backlighting 141 increases the reading convenience and, for an internal display module 14, simultaneously serves as an overvoltage protector. According to FIG. 2, the external display module 14 comprises a receiver unit 145 and a display 142. The external display module 14 can comprise a digital logic unit 146. The external display module 14 can comprise an additional user input 168.

The housing 151, 152 contains the electronic and mechanical components and optionally offers a mount or view window for the display 142. The housing is also constructed in such a manner that it protects the electronic components from contact with water. The housing, preferably the interior part 151, is equipped with a device such as a thread or a coupler that enables easy connection to a water faucet, a shower head, a shower hose or a garden hose. In a preferred configuration of the variant with an external display module 14, the measurement module, see FIG. 2 at the top, replaces the conventional water stream regulator of a water faucet. The water-conducting interior part of the housing 151 contains a screen 153 with which the rotating parts are protected from contamination. An optional water stream regulator 154 can be mounted at the water outlet of the device. A flow limiter 155 can also be mounted, which further increases the savings effect of the device, as well as protects the device from excessively large flow quantities.

A mounting position of the device shown in FIGS. 1 and 2 can be on a water faucet, for example. The device shown in FIG. 2 can be used as a replacement for a conventional water stream regulator.

The microcontroller 16 can be subdivided into several functional modules, including a module 161 for measuring the flow quantity, a module 162 for temperature measurement, a module 163 for estimating the expended energy quantity; a module 164 for management of the display, a data memory 165, a module for power management 166, a module 167 for management of the data communications 167, a module 168 for detecting and evaluating user inputs, as well as a module 169 for recognizing related withdrawal processes, wherein individual functions can also be subdivided in a different manner between the modules, and individual modules can be combined into larger functional units.

The module 161 for measuring the flow quantity determines the rotational frequency of the generator 11 and calculates therefrom the quantity of water that flows through the device per time unit. Indicators of the rotational frequency are the generated voltage and the frequency of the voltage. To determine the frequency of the voltage, the time difference is determined between two polarity changes or zero-crossing points for a defined edge, or between falling below and exceeding a defined voltage for a defined edge. This can be done with the aid of a comparator, a logic input or an analog-digital converter. Alternatively, the signal can be acquired with an analog-digital converter and its digital representation evaluated using pattern recognition. The frequency is translated into the flow quantity per time unit V_unit with a device-specific multiplier, primarily as a function of the selected channel width 4 and the configuration of the turbine wheel 111, as well as a possible bypass for application fields with high flow quantities. The successive values of V_unit are summed up over the withdrawal period and provided as a volume per withdrawal process V_ext. To improve the measurement precision, the inertia of the rotor can be compensated by an offset value and nonlinearities can be reduced with the aid of the respective characteristic curves.

The water temperature at the outlet of the device is acquired with the aid of a temperature sensor 12 and evaluated with the temperature module 162. The temperature sensor 12 supplies either an analog value digitized by an analog-digital converter, or a digital representation of the measurement value. The temperature module 162 supplies the digital value of the current temperature T_act as well as the minimum value T_min during the most recent M withdrawal processes, where M is an application-specific constant between 8 and 1024. T_min is set on delivery or after a reset to an application-specific value between 4° C. and 20° C. T_min is used to estimate the water temperature before heating, under the assumption that at least one withdrawal process of cold water occurred during M withdrawal processes. A more precise determination of the heat quantity is possible with this structure, without having to integrate a sensor in the cold water reservoir. The temperature module 162 can be calibrated in a defined environment during programming of the device. Alternatively, a base value for T_min can be determined, such as the mean temperature that water has when fed to a supply network.

The module 163 for acquiring the energy quantity accesses the module 161 for measuring the volume and the temperature module 162 in order to estimate the heat quantity that was supplied for the provision of the hot water. For this purpose, the quantity of water flowing to each device during a water withdrawal per time unit V_unit is multiplied by the difference between the temperature measured in this interval T_act and T_min, and the individual products are summed up and are multiplied by the specific heat storage capacity for water. The heat quantity supplied per withdrawal process E_ext is corrected if necessary by an assumed efficiency of the heat exchanger as well as by the heat losses during water transport. Heat losses during transport of water can be taken into account by addition of a value that results from the water temperature at the end of the withdrawal process of the withdrawn quantity of water until the water temperature at the beginning of the withdrawal process is reached and the specific heat capacity of water, which corresponds to an approximation of the quantity of heat remaining in the pipe system. The efficiency of the heat exchanger is taken into account by multiplication by a value greater than one. The quantity of heat expended E_ext can be expressed in watt hours, kilowatt hours or some other unit for energy. E_ext and V_ext can be further used to estimate the resulting greenhouse gas emissions for a withdrawal process. For this purpose, E_ext is multiplied by a constant that describes the emission per energy quantity, for example in grams of carbon dioxide equivalent per kilowatt hour, of a system for providing hot water (for an average system on delivery and adaptation to oil heating, solar collectors, etc. if necessary) and is added to the product of V_ext and the average emission per volume unit for providing cold water. The energy quantity E_ext can be supplemented with the quantity of energy for providing drinking water, in particular, by adding the product of V_ext and the average quantity of energy per volume unit for providing cold water. The costs per water withdrawal can be specified via an addition of the product of the quantity of heat energy for the withdrawal and the specific energy costs, as well as the product of the withdrawn water volume and the costs for fresh water and wastewater.

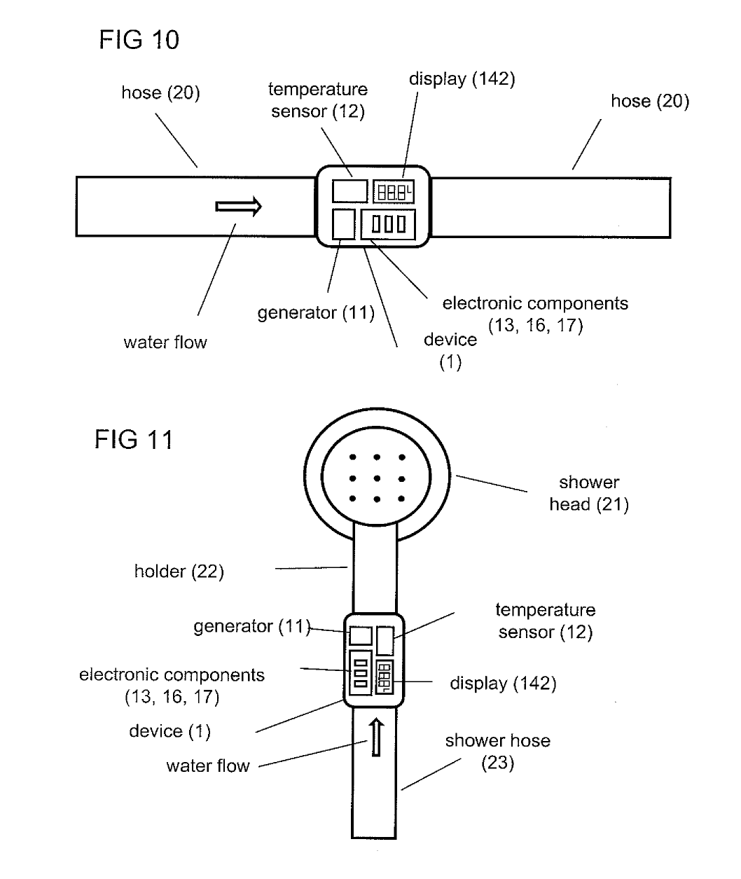

The module 164 for controlling the display uses the results of the module 161 for measuring the volume, the temperature module 162, the module 163 for determining the energy quantity, in particular, including costs and emission data, or a combination thereof in order to represent the implications of the ongoing or recently finished withdrawal process. The module 164 can alternate between two or more measured values or can represent one measured variable preferably or exclusively. The preferred displayed measured variable can be preset or can be selected automatically via a recognition of the relevant application. The instantaneous flow quantity and the water temperature in particular are used as an indicator for this; the display of the heat quantity can be omitted if only cold water is withdrawn, for example; if the water flow is slowly reduced by the user, this can be inferred to be a metered process and the variable describing the removed volume is preferably displayed, see FIG. 9.

The memory module 165 preferably includes a nonvolatile data memory that is integrated into the microcontroller 16. The module 165 is used to determine the minimum water temperature T_min of the most recent M withdrawal processes and to save it. In addition, T_act, V_ext, and E_ext are stored. The average values and accumulated measured variables from several preceding measurement periods can likewise be stored in order to detect trends in the user behavior. The memory module 165 can also store the program variables. For more elaborate evaluation methods, data on the individual withdrawal processes can also be stored. If it is advantageous for the construction, the memory module 165 can also be integrated as an external component.

The module for power management 166 recognizes critical states of the supply voltage VDD, for example, because of an excessively low rotational frequency of the generator 11 and consequently an expected discharge of the smoothing capacitors C1, C31, C32. In this case, the module 166 initiates a backup of the program variables and the current measured values in the memory module 165, brings the microcontroller 16 into a defined state and ensures the recovery of the operating state after the voltage goes back up.

The communication module 167, optional for an internal display module 14, is used as a data interface to an external device, which enables a more comprehensive storage, evaluation and display of the consumption data, if required. Possible transmission technologies include optical or radio frequency-based methods, in which data are transferred via amplitude shift keying, abbreviated ASK, differential phase shift keying, abbreviated DPSK, on-off keying, abbreviated OOK, or combined modulation techniques. In a preferred configuration, the backlighting 141 serves as a transmitter, wherein the communication module 167 of the microcontroller 16 performs a modulation if the generator voltage in the forward direction is greater than the on-state voltage of the LED D3. In order to maximize the on-time of the diode D3, the diode D3 is switched on and off with the aid of a parallel-connected transistor T1 rather than one connected in series, see FIG. 6.

FIG. 6 shows a possible circuit diagram of the rectifier module for the device described in FIG. 1 or the described method with the optional configuration for optical data transmission. In place of the diode D3, two LEDs can optionally be employed to utilize both half-waves and to protect against excessively high off-state voltages. The diode D2 can optionally be replaced by a bridge rectifier.

The optional user input module 168 makes it possible to define or select given parameters and thus to improve the accuracy of the measurements and calculations. The user can thus select the heat source used to prepare hot water, in particular, oil heating, gas heating, electrical instantaneous water heaters, solar collectors etc. and determine the parameters with respect to emission data and costs. The costs for fresh water and wastewater can also be input. It is further possible under certain circumstances to select desired display modes or defined units of the measured variables, or to bring the device into the state set upon delivery, “reset.” The input module 168 can likewise be used to calibrate the device, particularly the modules for temperature and flow measurement 161, 162. The user input mode can be activated via a defined sequence of short and long water withdrawals, “sequences.” If the user input mode is activated, individual parameters or menu options can be selected and modified via defined sequences.

The module 169 for recognizing related withdrawal processes recognizes and combines water withdrawals that very probably belong to one withdrawal process, or initiates new measurements for water withdrawals that should very probably be ascribed to new withdrawal processes. This makes it possible to automatically assign measurements to individual activities or work steps of a user and to prepare the results in such a manner that no calculations by the user are necessary, which increases the perceived value of the information. For this purpose, the device additively combines the measured values for individual withdrawals if the time span between two withdrawals is less than the value t_diff, wherein t_diff is dynamically selected in a preferred embodiment as a function of the ongoing or previous withdrawal process V_ext and as a function of the water temperature T_act. Alternatively, t_diff can be established as a static parameter. In addition, characteristic time spans for typical activities can be used as a basis for grouping or separating withdrawal processes, e.g., hand-washing t_diff<120 sec; tooth-brushing t_diff<240 sec; showering t_diff<240 sec; dish-washing t_diff<360 sec. In general it should hold for t_diff that 1 sec<t_diff<5 min. If a large amount of water is withdrawn for an ongoing withdrawal process, over 10 liters for example, a larger value will tend to be assumed for t_diff, such as 2 sec<t_diff<15 min. If the device is in metered mode, a new withdrawal process initiated by the user with a high flow quantity per time unit leads, even at a value of 1 sec<t_diff<1 min, to an assignment to a new withdrawal process, see FIG. 9.

In a preferred embodiment, a counter of the microcontroller 16 serves as a basis for determining the time between two withdrawals, so that a real-time clock can be omitted. Between two withdrawal processes it is possible that the charge stored in the smoothing capacitors of the rectifier module 13 is not sufficient for operating the counter and—if a real-time clock is omitted—no time basis will be available. In this case, the voltage difference at a defined discharging capacitor shortly before the switch-off of a microcontroller 16 and shortly after it is switched back on can be detected with the aid of an analog-digital converter and used to estimate the time difference between the switch off and switch on process. Alternatively, the water temperature can be detected shortly before the switch off and compared to the water temperature shortly after the subsequent switch on. Under the assumption of an approximation to the ambient temperature, it is thus likewise possible to infer the time difference. The methods of detecting the charge state and the temperature can be combined.

The peripheral components 17 support the operation of the previously mentioned components.

An advantageous configuration of the invention is achieved by a division of the measurement unit and the display unit; the schematic structure as well as the block diagram are shown in FIGS. 2 and 5. In particular, smaller models of the unit to be placed at the withdrawal site can be achieved in this way, which are easier to integrate into existing withdrawal sites; in addition, the mounting of the display unit in the visual field of the user can be easily achieved. Preferred transmission technologies are optical or radio frequency-based methods, in which data are transferred via amplitude shift keying, abbreviated ASK, differential phase shift keying, abbreviated DPSK, on-off keying, abbreviated OOK, or combined modulation techniques. The energy required to transmit the data can be reduced by varying the amplitude as well as the time intervals between two amplitudes for the encoding of the data.

Particularly due to the limited electrical energy available for transmitting a data packet, the amount of data to be transmitted per packet must be kept as small as possible; at the same time, individual data packets must contain as much information as possible since the number of data packets that can be transmitted per time unit is likewise restricted. Depending on the position of use or the ambient conditions of a device for applying the described method, it can be advantageous to transmit data or data packets that allow a display or calculation of the consumption information without knowledge of the previously transmitted information; this applies particularly if the transmission channel is highly susceptible to interference; or it can be advantageous to transmit data that allow a display or calculation of the consumption information with knowledge of the previously transmitted data, which allows a reduction of the data volume per data packet. This is particularly advantageous if the bandwidth of the transmission system is sharply restricted, or the display must be updated at a high frequency. In addition, a combination of the two methods can be advantageous, in which, for example, data enabling a display or calculation of the consumption information without knowledge of the previously transmitted information are transmitted alternately with a sequence of data that enable a display or calculation of the consumption information with knowledge of the previously transmitted data. This favors an updating of the display at a higher frequency with reduced data volumes to be transmitted and a simultaneous reduced probability of a display that is erroneous for a long time.

In addition, address information that permits an identification of different measurement modules can be transmitted, or the data sent by different measurement modules can be differentiated based on the data themselves. If for example, counter states or temperature values with sufficient time resolution are continuously transmitted, then assuming continuity of the values, there can be a differentiation based on the values themselves or on the values together with the first or second derivative over time of the curve of the values versus time.

Additionally, the size of a data word, optionally forgoing redundancies for error correction, the accuracy or the time resolution, can be adjusted as a function of the energy available to the transmitter. With a low flow quantity per time unit for example (and an associated relatively low energy available for data transmission), data can be transmitted as 3 to 6 bit-long data packets, and in case of a high flow quantity per time unit (and an associated relatively large amount of energy available for data transmission) data can be transmitted as 4 to 16 bit-long data packets. The length of the data packets themselves can be used as information available to the receiver for supporting the interpretation of the data packets.

In a preferred configuration, synchronization information, such as absolute measurement values, with a word length of 4 or more bits, optionally distributed over several data packets, follows several information items with a relatively short word length of 1 to 16 bits used for updating. In a preferred configuration, information on the volume of the fluid flowing through the apparatus is transmitted as binary data packets according to the above-described method, and the temperature of the fluid is encoded as the time interval between two or more bits to be transmitted. Likewise, information on the temperature of the fluid flowing through the apparatus can be transmitted as binary data packets according to the above-described method, and the volume of the fluid can be encoded as the time interval between two or more bits to be transmitted.

Existing methods for determining the resource consumption in the usage of hot or cold water do not promote an easy assessment of personal behavior by the user, since consumption information is not displayed on the level of individual activities. This limits possible learning effects with respect to an economical usage of the resource.

A method has been specified with which the effects on the environment resulting from the consumption, as well as the costs incurred, can be determined and displayed at the site of withdrawal of a fluid or at the location of the controller of the withdrawal process. In particular, related withdrawal processes are recognized with the aid of pattern recognition, so that an activity-related assessment of the behavior can take place within a short time. The amount of heat energy input into the fluid is determined with the aid of a temperature sensor in the device and an estimation of the temperature before the heat treatment. If desired, the consumption information is displayed in combination with comparative information or information on the development of the resource consumption over time.

For a large part of the users, the indication of consumption information on the level of individual activities promotes an economical handling of these very resources and thus reduces the consumption as well as the resulting environmental effects.

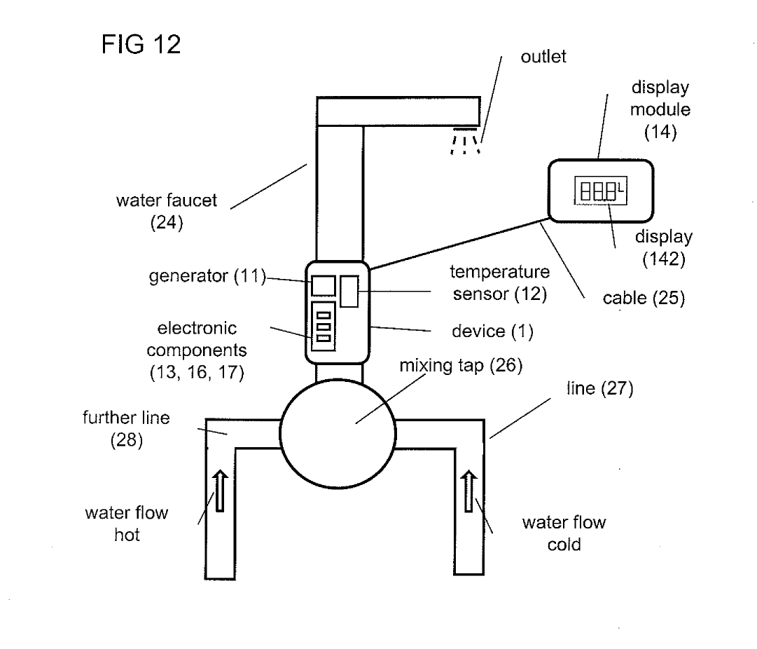

FIG. 10 shows an exemplary embodiment of a water withdrawal device realized as a hose 20. The device 1 is integrated in the hose 20. The device 1 can be realized as is shown in the previous figures, especially in FIGS. 1 to 5. The device 1 is inserted between two parts of the hose 20. The hose 20 can be implemented as a shower hose. The device 1 comprises the generator 11, the temperature sensor 12, electronic components 13, 16, 17 and the display 142. The electronic components comprise the rectifier module 13, the microcontroller 16 and peripheral components 17. The peripheral components 17 may, for example, comprise the infrared transmitter 130. Water flowing in the hose 20 has the effect that the generator 11 generates the output voltage which depends on the flow rate of the water flowing through the hose 20. The frequency and/or the amplitude of the output voltage of the generator 11 depend on the flow rate. The temperature sensor 12 measures the temperature of the water flowing in the hose 20. The electronic components 13, 16, 17 generate a first signal by means of the output voltage of the generator 11. The first signal indicates the quantity of fluid flown through the hose 20. Furthermore, the electronic components generate a second signal depending on the output voltage and the temperature signal of the temperature sensor. The second signal indicates the quantity of energy which is expended in providing the warm water. The first and/or the second signal are displayed on the display 142.

In an alternative embodiment, which is not shown, the device 1 is realized without the temperature sensor. The device 1 only generates the first signal indicating the quantity of water. The hose 20 may be realized as a garden hose.

In an alternative embodiment, which is not shown, the device 1 is integrated in a water line instead of the hose 20.

FIG. 11 shows an exemplary embodiment of a shower head 21. A shower hose 23 is connected to the shower head 21. A holder 22 is arranged between the shower hose 23 and the shower head 21. The device 1 is arranged between the shower hose 23 and the holder 22. The device 1 is realized as shown in FIGS. 1 to 5 and FIG. 10. Water flows through the shower hose 23, the device 1 and the holder 22 to the shower head 21.

In an alternative embodiment, which is not shown, the device 1 is integrated in the shower hose. Alternatively, the device 1 is integrated in the holder 22 or in the shower head 21.

FIG. 12 shows an exemplary embodiment of a water withdrawal device which is realized as a mixing tap 26. The mixing tap 26 can also be named mixer tap. The mixing tap 26 comprises two inlets and one outlet. The two inlets of the mixing tap 26 are connected to a line 27 and a further line 28. The line 27, 28 can also be named water line or water pipe. The outlet of the mixing tap 26 is connected to a faucet 24. The faucet 24 can also be named water faucet or tap. The device 1 is connected to the outlet of the mixing tap 26. The device 1 is integrated in the pipe between the mixing tap 26 and the faucet 24. The mixing tap 26 comprises a lever (not shown) which controls the flow rate of the water flowing through the outlet of the mixing tap 26. Furthermore, the lever controls the ratio of the flow rate of water flowing through the line 27 to the flow rate of water flowing through the further line 28. Cold water flows through the line 27 and hot water flows through the further line 28. Thus, the temperature of the water flowing through the faucet 24 can be determined by the position of the lever of the mixing tap 26. The display module 14 is connected to the device 1 via a cable 25.

In an alternative embodiment, which is not shown, the display module 14 is integrated at the device 1.

In an alternative embodiment, which is not shown, the device 1 is integrated in the water faucet 24.

The scope of protection of the invention is not limited to the examples given hereinabove. The invention is embodied in each novel characteristic and each combination of characteristics, which includes every combination of any features which are stated in the claims, even if this feature or combination of features is not explicitly stated in the examples.

We claim:

1. An arrangement for determining resource consumption, comprising:
a generator for generating an output voltage by means of a fluid, water in particular, flowing through the arrangement during a withdrawal unit, wherein the generator comprises a turbine wheel that is configured to be set into rotational motion by the fluid flowing through the arrangement and the generator is adapted to generate the output voltage of the generator in such a manner that the output voltage of the generator can operate an electronics component, and
the electronics component that is adapted to determine from the output voltage of the generator a fluid quantity of the fluid flowing through the arrangement during the withdrawal unit, wherein the withdrawal unit is an individual withdrawal process or, if the individual withdrawal processes take place in a time interval that is smaller than a predetermined time window, an overall withdrawal process composed of several individual withdrawal processes, and
provide a signal indicating the resource consumption as a function of the output voltage of the generator.

2. The arrangement according to claim 1,
wherein the arrangement is configured to determine the fluid quantity of a first and a second individual withdrawal process separately as the fluid quantity of the withdrawal unit, if the first and the second withdrawal process take place in a time interval that is larger than the predetermined time window.

3. The arrangement according to claim 1, comprising a temperature sensor for providing a temperature signal that depends on a temperature of the fluid, wherein the electronics component is configured to provide the signal for indicating the resource consumption as a function of the temperature signal and the output voltage of the generator.

4. The arrangement according to claim 3, wherein the electronics component is configured to provide the signal for indicating the resource consumption also as a function of a base temperature, and a measured lowest temperature during a number M of preceding individual withdrawal processes, or a base value is defined as the base temperature.

5. The arrangement according to claim 1, wherein the electronics component comprises a microcontroller that is designed to combine individual withdrawal processes into an overall withdrawal process by means of an evaluation of a duration of individual withdrawal processes and the time intervals between two or more individual withdrawal processes.

6. The arrangement according to claim 1, wherein the turbine wheel is produced from magnetized material or is connected to at least one magnet.

7. The arrangement according to claim 1, comprising an interior housing, wherein the generator comprises at least one coil and the at least one coil is mounted on a side of the interior housing facing away from the fluid such that an alternating magnetic field flows through the at least one coil during the rotational movement.

8. The arrangement according to claim 1, comprising a display module for a display of the signal indicating the resource consumption.

9. A water withdrawal device, in particular a device of a group comprising a water faucet, shower head, shower hose, mixing tap, garden hose and water line, comprising an arrangement according to claim 1.

10. A method for determining resource consumption in the usage of a fluid withdrawn at a withdrawal site, in particular water, taking into account a quantity of fluid and temperature values associated with the quantity of fluid,
comprising the steps of:
obtaining the quantity of fluid withdrawn at the withdrawal site during a withdrawal unit to determine the resource consumption, wherein the withdrawal unit is an individual withdrawal process or an overall withdrawal process composed of several individual withdrawal processes, and the quantity of fluid is
either the quantity of fluid of the individual withdrawal process
or the quantity of fluid of the overall withdrawal process;
taking into consideration the overall withdrawal process if the individual withdrawal processes take place in a time interval that is smaller than a predetermined time window;
subdividing each individual withdrawal process into partial withdrawal processes associated with time units;
determining an average temperature of the withdrawn fluid as the actual temperature for each partial withdrawal process;
determining a temperature value per time unit from the difference between the actual temperature and a base temperature; and
determining the resource consumption based on the fluid quantity measured during the withdrawal unit as well as the temperature values determined during the withdrawal unit, wherein an output voltage of a generator is applied both as an indicator of the flow quantity and for supplying a voltage to the electronics components and the generator comprises a turbine wheel that is set into rotational motion by the fluid flowing through the arrangement.

11. The method according to claim 10, wherein a measured lowest temperature during a number M of prior individual withdrawal processes is determined as the base temperature.

12. The method according to claim 10, wherein a time t with 1 sec t 5 min is defined as the time window.

13. The method according to claim 10, wherein the consumption information comprises data on the withdrawn volume of water.

14. The method according to claim 10, wherein the information comprises data on the quantity of energy expended in providing hot water.

15. The method according to claim 10, wherein the water flow through the device drives the turbine wheel that is itself magnetized or is rigidly connected to permanent magnets, wherein an alternating magnetic field is generated in one or more coils during a rotational motion of the turbine wheel and thus an AC voltage is generated whose curve over time is applied as an indicator for the flow amount and that additionally supplies the device with electrical energy.

16. The method according to claim 10, wherein a supply voltage is limited with the aid of light-emitting diodes that are applied for lighting the display.

17. The method according to claim 10, wherein the cost-relevant and the environmentally relevant information from previous measurements or from other user groups is related to the measured values in order to facilitate comparisons.

18. The method according to claim 10, wherein the user behavior can be classified into efficiency classes.

19. An arrangement for determining resource consumption, comprising:
a generator comprising a turbine wheel and a coil, wherein the generator is configured that the turbine wheel is set into rotational motion by a fluid flowing through the arrangement, the turbine wheel generates an alternating magnetic field in the coil and a supply voltage for an electronics component is provided from an output voltage of the generator;
a temperature sensor that is configured to provide a temperature signal which depends on a temperature of the fluid; and
the electronics component that is configured to provide a signal for indicating a resource consumption as a function of the temperature signal and the output voltage of the generator.
